(19) United States
(12) Patent Application Publication
(10) Pub. No.: US 2022/0312718 A1
(43) Pub. Date: Oct. 6, 2022

(54) MILKING MACHINE AND ASSEMBLY

(71) Applicants: ADAM SILVIANU, KIRYAT-HAIM (IL); RAN SILVIANU, KIRYAT-HAIM (IL)

(72) Inventors: ADAM SILVIANU, KIRYAT-HAIM (IL); RAN SILVIANU, KIRYAT-HAIM (IL)

(21) Appl. No.: 17/694,908

(22) Filed: Mar. 15, 2022

(30) Foreign Application Priority Data
Apr. 1, 2021 (IL) 281971

(51) Int. Cl. A01J 5/04

(52) U.S. Cl. CPC A01J 5/044; A01J 5/041

(57) ABSTRACT

A milking machine, including a milking claw for each animal, the milking claw including an air inlet for being connected to a vacuum pump, and a milk outlet, a plurality of milking assemblies, each for being connected to one udder of the animal, each of the milking assemblies including a) a first end for being connected to the animal udder for pumping milk from the udder, and b) a quick connection member, and a connection assembly being connectable to the milking claw, the connection assembly including a plurality of quick connection members, each for connecting to one of the quick connection members of the milking assemblies, thereby allowing quick connection between each of the milking assemblies to the milking claw.

### CROSS-REFERENCE TO RELATED APPLICATIONS

This application claims the benefit of priority from Israel Patent Application No. 281971, filed Apr. 1, 2021, the disclosure of which is incorporated herein by reference.

### TECHNICAL FIELD

The invention relates to the field of milking machines.

### BACKGROUND

FIG. 1 depicts a prior art milking machine.

A prior art milking machine 77 includes a milking cluster 62A, each for one cow or goat 64; and a vacuum pump 68A, serving other milking clusters for other cows.

Milking cluster 62A includes a milking claw 60 for being connected to vacuum pump 68A; four milk tubes 12A, each for connecting to one udder 70 of cow 64, and extending from a teat cup 14A to milking claw 60; and four air tubes 18A, each extending from one of teat cups 14A to milking claw 60.

Milking cluster 62A may be regarded as including one milking claw 60 and four milking assemblies 66A; wherein each milking assembly 66A includes one teat cup 14A, one milking tube 12A, and one air tube 18A.

FIG. 2 is a front sectional view of the prior art milking assembly of FIG. 1 as marketed.

The central portion 13B of milk tube 12A is disposed within teat cup 14A. At the marketed state of FIG. 1, udder end 13C of milk tube 12A is sealed to teat cup 14A, whereas the rest is not sealed for not stretching milk tube 12A, for not shortening its availability. Thus, at this marketed state, air 21A pumped by air tube 18A, exits without providing any pumping effect.

FIG. 3 is the front sectional view of the prior art milking assembly of FIG. 2 upon sealing the milk tube to the teat cup.

The farmer then pulls the milking claw end 13A of milk tube 12A extending from teat cup 14A in relation to teat cup 14A being rigid and non-shape changeable, to stretch (72) milk tube 12A, for sealing (74) milk tube 12A to teat cup 14A.

FIG. 4 is the front sectional view of the prior art milking assembly of FIG. 3 upon vacuuming.

Vacuum pump 68A of FIG. 1 then presses air 21A into teat cup 14A, thus to space 40 between teat cup 14A and central portion 13B of milk tube 12A. Since central portion 13B of milk tube 12A is disposed within teat cup 14A, and since teat cup 14A is rigid whereas milk tube 12A is resilient, central portion 13B of milk tube increases and diminishes by air 21A, thus pumping milk 21B within milk tube 12A.

However, the pulling of the end zone of milk tube 12A to produce sealing 74, and the connection of milk tube 12A and air tube 18A to milking claw 60 are difficult operations, which must all be done by the farmer.

There is a long felt need to provide a solution to the above-mentioned and other problems of the prior art.

### SUMMARY

A milking machine, including:
a plurality of milking assemblies, each including a quick connection member; and
a connection assembly including a plurality of quick connection members, each for connecting to one of the quick connection members.

### BRIEF DESCRIPTION OF THE DRAWINGS

Embodiments, features, and aspects of the invention are described herein in conjunction with the following drawings:

FIG. 1 depicts a prior art milking machine.

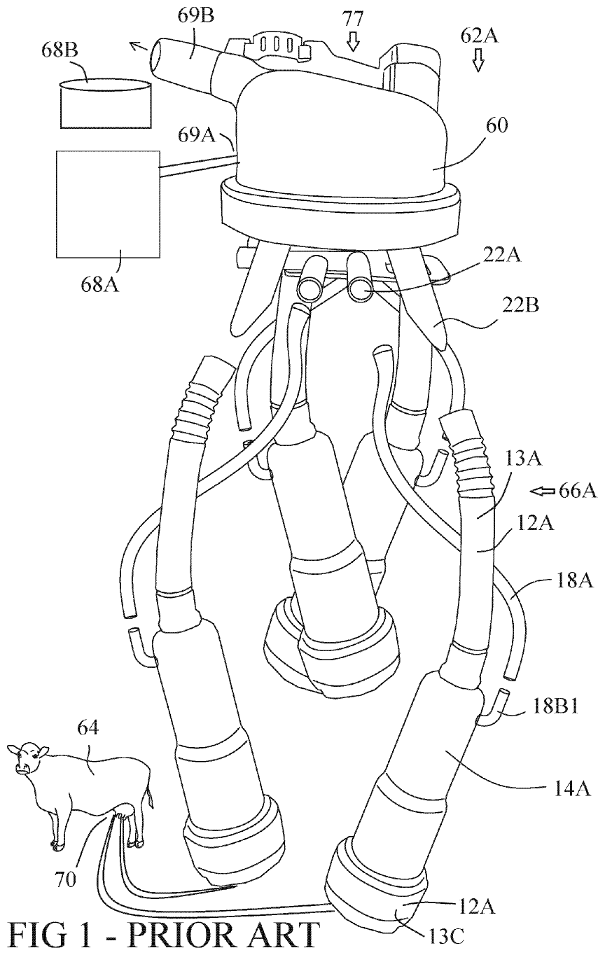

FIG. 2 is a front sectional view of the prior art milking assembly of FIG. 1 as marketed.

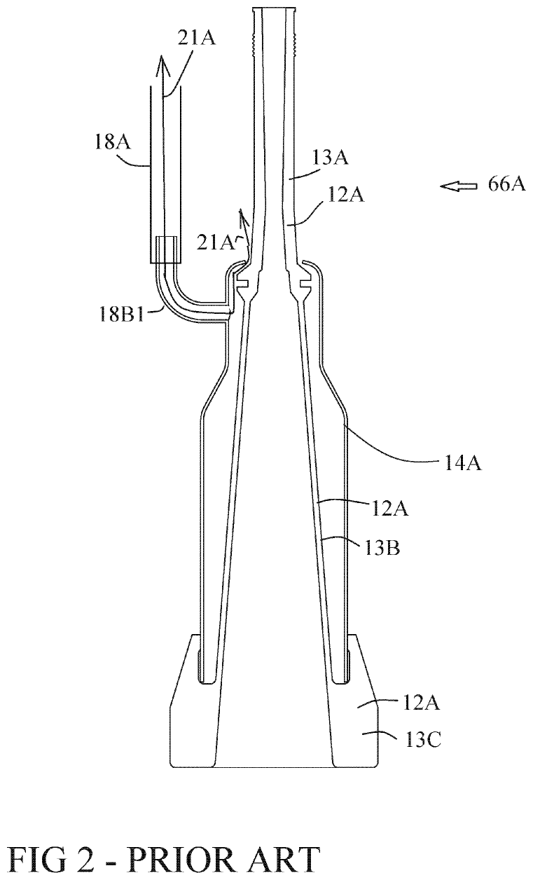

FIG. 3 is the front sectional view of the prior art milking assembly of FIG. 2 upon sealing the milk tube to the teat cup.

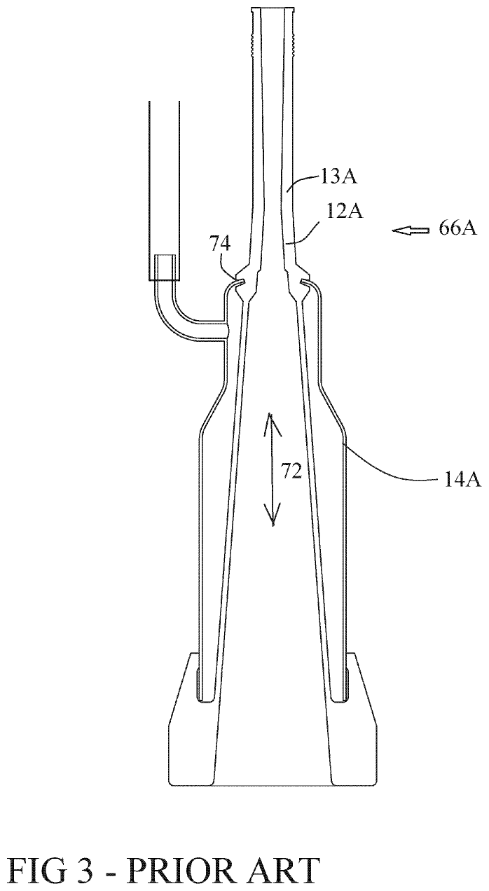

FIG. 4 is the front sectional view of the prior art milking assembly of FIG. 3 upon vacuuming.

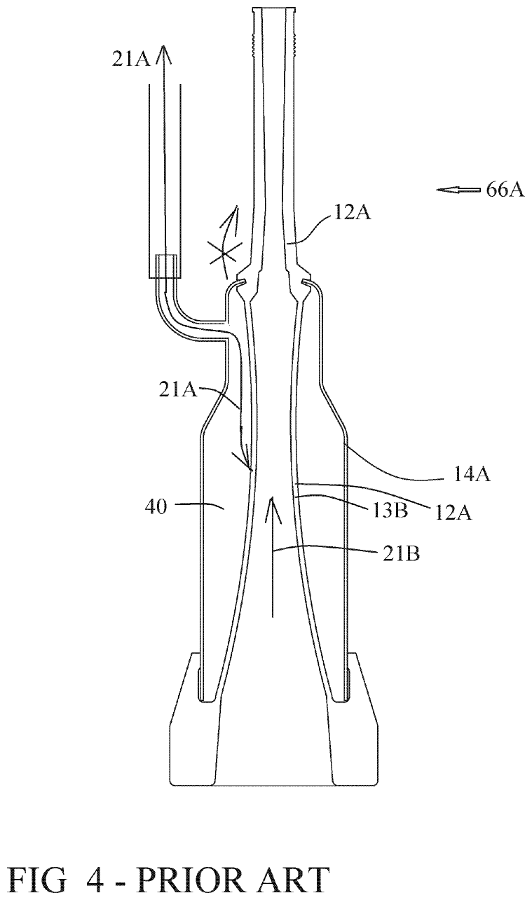

FIG. 5 depicts a milking machine according to one embodiment of the invention, prior to connecting the milking assemblies.

FIG. 6 is a front sectional view of the quick connection member of the connection assembly, and of the milking assembly as marketed, being separated from each other as of FIG. 5.

FIG. 7 depicts the milking machine of FIG. 5 upon connecting the milking assemblies.

FIG. 8 is the front sectional view of the milking assembly of FIG. 6 upon operating the first step of FIG. 7.

The drawings are not necessarily drawn to scale.

### DETAILED DESCRIPTION

The invention will be understood from the following detailed description of embodiments of the invention, which are meant to be descriptive and not limiting. For the sake of brevity, some well-known features are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

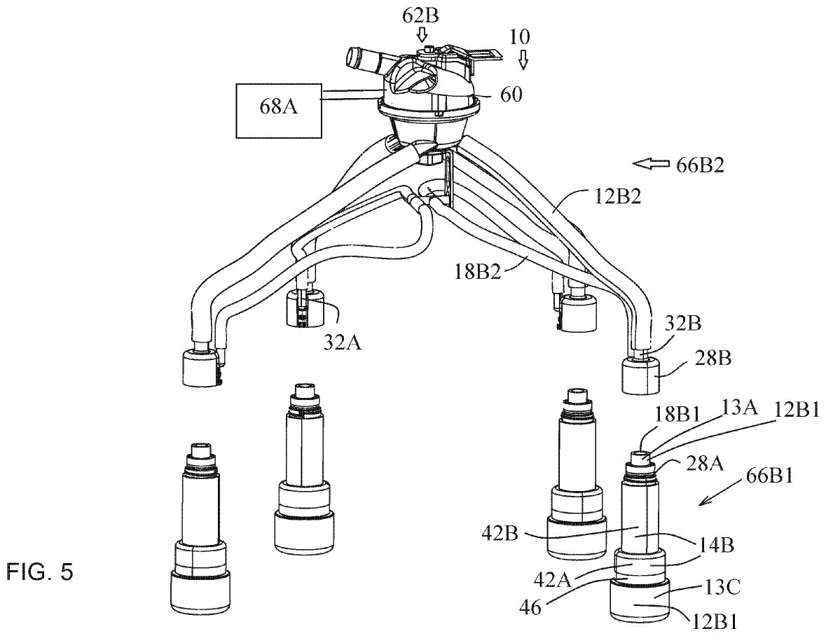

FIG. 5 depicts a milking machine according to one embodiment of the invention, prior to connecting the milking assemblies.

A milking machine 10 according to one embodiment of the invention includes a milking cluster 62B, each for one cow; and prior art vacuum pump 68A, serving other milking clusters for other cows.

Milking cluster 62B includes prior art milking claw 60 for being connected to vacuum pump 68A; four teat cups 14B, each for connecting to one udder of the cow; four springy stretchable milk tubes 12B1, each extending from one teat cup 14B; and four air inlets 18B1, each extending from one of teat cups 14B.

However, milking claw ends 13A of milk tubes 12B1 are not connected directly to milking claw 60, but rather through milk tubes 12B2 being connected at their other end zones to milking claw 60; and air inlets 18B1 are not connected directly to milking claw 60, but rather through connection air tubes 18B2 being connected at their other end zones to milking claw 60

Milking cluster 62B may be regarded as including one milking claw 60; four milking assemblies 66B1; and a connection assembly 66B2, for connecting milking claw 60 to four milking assemblies 66B1.

Detailing the above, each milking assembly 66B1 includes one teat cup 14B, one milking tube 12B1, one air inlet 18B1, and a quick connection member 28A, such as a male thread; and connection assembly 66B2 includes four milk tubes 12B2, four connection air tubes 18B2, and four quick connection members 28B, each being connectable to one quick connection member 28A of one milking assembly 66B1.

In contrast to prior teat cup 14A being rigid and non-shape changeable, teat cup 14B is telescopic as including telescopic members 42A and 42B.

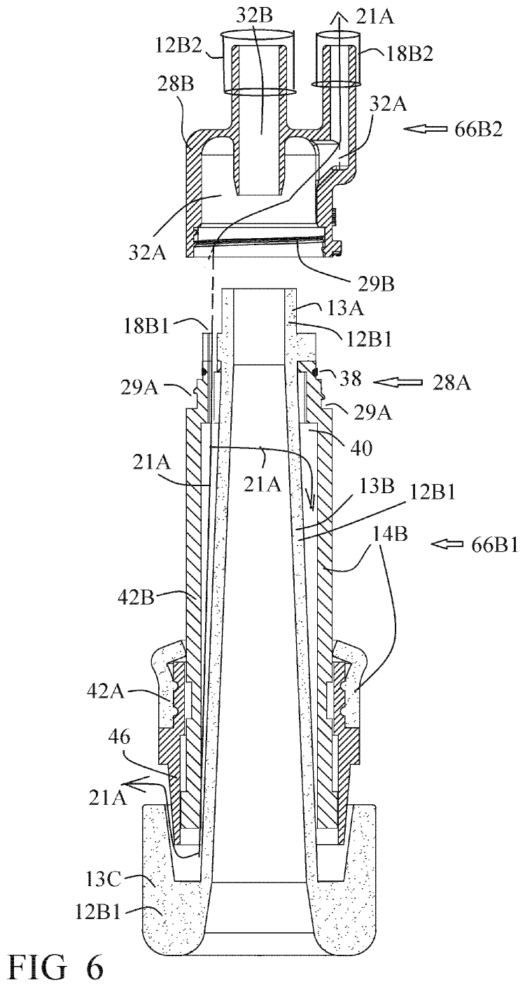

FIG. 6 is a front sectional view of the quick connection member of the connection assembly, and of the milking assembly as marketed, being separated from each other as of FIG. 5.

The central portion 13B of milk tube 12B1 is disposed within teat cup 14B. At the marketed state of FIG. 6, milking claw end 13A of milk tube 12B1 is sealed to teat cup 14B, whereas udder end 13C of milk tube 12B1 is not sealed to teat cup 14B. Thus, air 21A provided by air inlet 18B1, exits without pumping.

Quick connection member 28A of milking assembly 66B1 includes a male thread 29A, for connecting to a female thread 29B of quick connection member 28B of connection assembly 66B2.

Quick connection member 28B of connection assembly 66B2 further includes a central milk passage 32B for being connected to its milk tube 12B2; and an air passage 32A for being connected to its air tube 12B2. Air passage 32A may surround milk passage 32B.

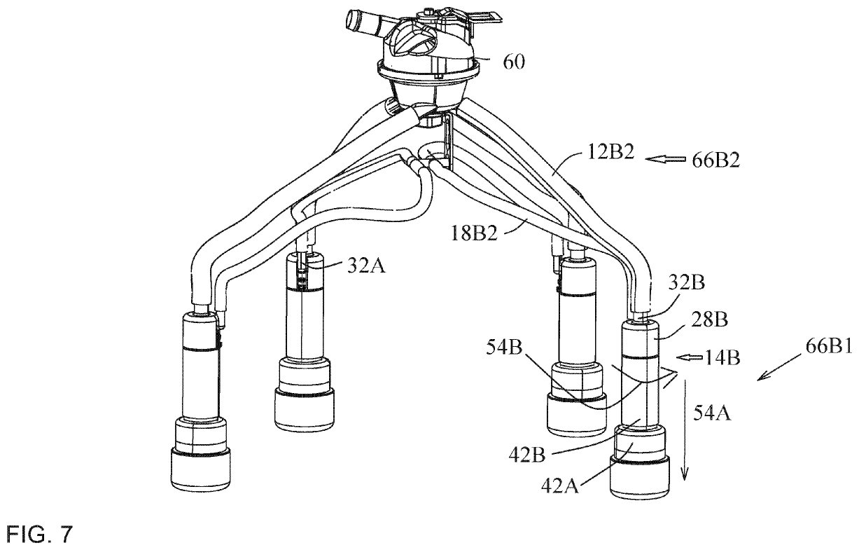

FIG. 7 depicts the milking machine of FIG. 5 upon connecting the milking assemblies.

Connecting milking assembly 66B1 to connection assembly 66B2 is applied by a first step 54A and then a second step 54B.

At first step 54A the farmer draws telescopic member 42A of teat cup 14B away from telescopic member 42B against springy force of milk tube 12B1.

As detailed following, first step 54A stretches milk tube 12B1; seals milk tube 12B1 to teat cup 14B; and locks telescopic members 42A and 42B of teat cup 14B one to the other.

At the second step 54B, the farmer slightly rotates connection member 28A of milking assembly 66B1 in relation to connection member 28B of connection assembly 66B2.

As detailed following, second step 54B induces sealing of milk tube 12B1 of milking assembly 66B1 to milk tube 12B2 of connection assembly 66B2, and induces sealing of air inlet 18B1 of milking assembly 66B1 to air tube 18B2 of connection assembly 66B2.

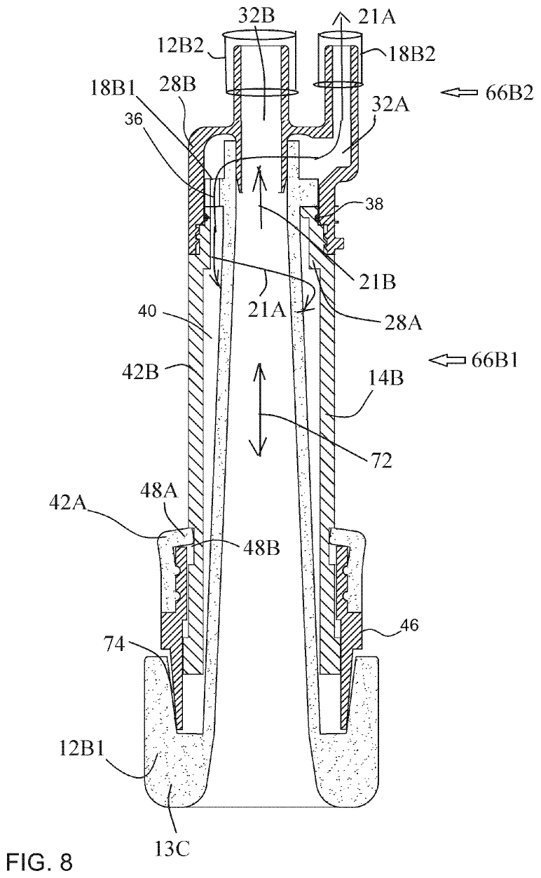

FIG. 8 is the front sectional view of the milking assembly of FIG. 6 upon operating the first step of FIG. 7.

At first step 54A the farmer draws telescopic member 42A of teat cup 14B away from 42B against springy force of milk tube 12B1.

Upon first step 54A, telescopic member 42A pulls the udder end 13C of milk tube 12B1, and telescopic member 42B pulls the milking claw end 13A of milk tube 12B1, thus first step 54A stretches (72) milk tube 12B1.

Further upon first step 54A, telescopic member 42A of teat cup 14B pushes a seal 46 onto udder end 13C of milk tube 12B1, and milking claw end 13A of milk tube 12B1 is sealed as marketed to telescopic member 42B of teat cup 14B, thus first step 54A seals milk tube 12B1 to teat cup 14B.

Further upon first step 54A, a protrusion 48A of telescopic member 42A enters a niche 48B of telescopic member 42B, thus first step 54A locks telescopic members 42A and 42B of teat cup 14B one to the other. Thus protrusion 48A and niche 48B constitute locking members.

At the second step 54B, the farmer slightly rotates connection member 28A of milking assembly 66B1 in relation to connection member 28B (FIG. 7) of connection assembly 66B2.

Upon second step 54B, milking claw end 13A of milk tube 12B1 of milking assembly 66B1 is sealed to milk passage 32B tube 12B2 of connection assembly 66B2, and air inlet 18B1 of milking assembly 66B1 is sealed to air passage 32A of connection assembly 66B2.

Thus, in one aspect, the invention is directed to a milking machine (10), including:
a milking claw (60) for each animal (64), the milking claw (60) including an air inlet (69A) for being connected to a vacuum pump (68A), and a milk outlet (69B);
a plurality of milking assemblies (66B1), each for being connected to one udder (70) of the animal (64), each of the milking assemblies (66B1) including:
a) a first end (13C) for being connected to the animal udder (70) for pumping milk from the udder (70); and
b) a quick connection member (28A); and
a connection assembly (66B2) being connectable to the milking claw (60), the connection assembly (66B2) including a plurality of quick connection members (28B), each for connecting to one of the quick connection members (28A) of the milking assemblies (66B1),
   thereby allowing quick connection between each of the milking assemblies (66B1) to the milking claw (60).

Each of the milking assemblies (66B1) may further include:
a milking tube (12B1) including a second end (13A) and the first end (13C); and
an air inlet (18B1),
   wherein each of the quick connection members (28B) of the connection assembly (66B2) may include an air passage (32A) and a milk passage (32B), and wherein the quick connection members (28A,28B) are configured to seal the air inlet (18B1) of the milking tube (12B1) to the air passage (32A) of the quick connection member (28B), and to seal the second end (13A) of the milking tube (12B1) to the milk passage (32A) of the quick connection member (28B).

Each of the milking assemblies (66B1) may further include:
a teat cup (14B) including telescopic members (42A,42B); and
a milking tube (12B1) including a second end (13A) and the first end (13C),
   wherein the telescopic members (42A,42B) are configured, by drawing thereof away from one another, to draw the first (13C) and second 13A) ends of the milking tube (12B1) away from one another, thereby to stretch (72) the milking tube (12B1).

The telescopic members (42A,42B) of the teat cup (14B) may include locking members (42A,42B), for locking the drawing the telescopic members (42A,42B) away from one another, thereby locking the state of the stretching (72) the milking tube (12B1).

The milking tube (12B1) and the telescopic members (42A,42B) of the teat cup (14B) may be configured to seal the milking tube (12B1) to the teat cup (14B) by the drawing telescopic members (42A,42B) away from one another.

In another aspect, the invention is directed to a milking assembly (66B1), including:
a milking tube (12B1) including a first end (13C) for being connected to an animal udder (70) for pumping milk from the udder (70); and
a teat cup (14B) including telescopic members (42A,42B), wherein sliding therebetween is configured to seal (74) the milking tube (12B1) to the teat cup (14B).

The milking assembly (66B1) may further include:
an air inlet (18B1); and
a connector (28A),
   wherein the milking tube (12B1) further includes a second end (13A), and wherein the connector (28A) is configured to connect concurrently both of the air inlet (18B1) and the second end (13A) of the milking tube (12B1) to a milking claw (60).

In the figures and/or description herein, the following reference numerals (Reference Signs List) have been mentioned:
numeral 10 denotes the milking machine according to one embodiment of the invention;
12A: milk tube of prior art milking machine 77;
12B1: milk tube of milking machine 10 and of milking assembly 66B1 thereof;
12B2: milk tube of connection assembly 66B2;
13A: milking claw end of milk tubes 12A,12B1;
13B: central portion of milk tubes 12A,12B1;
13C: udder end of milk tubes 12A,12B1;
14A: prior teat cup;
14B: teat cup of milking machine 10 and of milking assembly 66B1 thereof;
18A: air tube of prior art milking machine 77;
18B1: air inlet of milking assemblies 66A,66B1;
18B2: air tube of connection assembly 66B2;
21A: air;
21B: milk;
22A: air outlet of milking claw 60;
22B: milk inlet of milking claw 60;
28A: connection member of milking assembly 66B1;
28B: connection member of connection assembly 66B2;
29A: male thread of quick connection member 28A;
29B: female thread of quick connection member 28B;
32A: air passage of connection member 28B of connection assembly 66B2;
32B: milk passage of connection member 28B of connection assembly 66B2;
36: air passage;
38: seal for sealing connection members 28A and 28B one to the other upon being connected;
40: space between teat cup 14A,14B and central portion 13B of milk tube 12A,12B1;
42A,42B: telescopic members of teat cup 14B;
46: seal for obtaining sealing 74;
48A,48B: complementary locking members;
54A: drawing telescopic member 42A away from telescopic member 42B;
54B: rotating connection member 28A in relation to connection member 28B;
60: milking claw of milking machines 10,77;
62A: prior art milking cluster;
62B: milking cluster of milking machine 10;
64: animal, such as cow and goat;
66A: prior art milking assembly;
66B1: milking assembly according to one embodiment of the invention;
66B2: connection assembly;
68A: vacuum pump;
68B: milk basket;
69A: air inlet of milking claw 60;
69B: milk outlet of milking claw 60;
70: cow udder;
72: stretching of milk tubes 12A,12B1;
74: sealing between teat cup 14A,14B to milk tube 12A,12B1 applied upon preparing milking assembly 66A,66B for use; the sealing is not applied prior to the preparing for not shortening its availability;
77: prior art milking machine;

The foregoing description and illustrations of the embodiments of the invention have been presented for the purpose of illustration, and are not intended to be exhaustive or to limit the invention to the above description in any form.

Any term that has been defined above and used in the claims, should be interpreted according to this definition.

The reference numbers in the claims are not a part of the claims, but rather used for facilitating the reading thereof. These reference numbers should not be interpreted as limiting the claims in any form.

What is claimed is:

1. A milking machine, comprising:
a milking claw for each animal, the milking claw comprising an air inlet for being connected to a vacuum pump, and a milk outlet;
a plurality of milking assemblies, each for being connected to one udder of the animal, each of the milking assemblies comprising:
a) a first end for being connected to the animal udder for pumping milk from the udder; and
b) a quick connection member; and
a connection assembly being connectable to the milking claw, the connection assembly comprising a plurality of quick connection members, each for connecting to one of the quick connection members of the milking assemblies,
thereby allowing quick connection between each of the milking assemblies to the milking claw.

2. The milking machine according to claim 1, wherein each of the milking assemblies further comprises:
a milking tube comprising a second end and the first end; and
an air inlet,
and wherein each of the quick connection members of the connection assembly comprises an air passage and a milk passage, and
wherein the quick connection members are configured
to seal the air inlet of the milking tube to the air passage of the quick connection member, and
to seal the second end of the milking tube to the milk passage of the quick connection member.

3. The milking machine according to claim 1, wherein each of the milking assemblies further comprises:
a teat cup comprising telescopic members; and
a milking tube comprising a second end and the first end,
wherein the telescopic members are configured, by drawing thereof away from one another, to draw the first and second ends of the milking tube away from one another, thereby to stretch the milking tube.

4. The milking machine according to claim 1, wherein the telescopic members of the teat cup comprise locking members, for locking the drawing the telescopic members away from one another,
thereby locking a state of the stretching the milking tube.

5. The milking machine according to claim 1, wherein the milking tube and the telescopic members of the teat cup are configured to seal the milking tube to the teat cup by the drawing telescopic members away from one another.

6. A milking assembly, comprising:
a milking tube comprising a first end for being connected to an animal udder for pumping milk from the udder; and
a teat cup comprising telescopic members, wherein sliding therebetween is configured to seal the milking tube to the teat cup.

7. The milking assembly according to claim 6, further comprising:
an air inlet; and
a connector,
wherein the milking tube further comprises a second end, and
wherein the connector is configured to connect concurrently both of the air inlet and the second end of the milking tube to a milking claw.
